(19) United States
(12) Patent Application Publication
(10) Pub. No.: US 2011/0078775 A1
(43) Pub. Date: Mar. 31, 2011

(54) METHOD AND APPARATUS FOR PROVIDING CREDIBILITY INFORMATION OVER AN AD-HOC NETWORK

(75) Inventor: Zheng YAN, Espoo (FI)

(73) Assignee: Nokia Corporation, Espoo (FI)

(21) Appl. No.: 12/570,031

(22) Filed: Sep. 30, 2009

(51) Int. Cl. G06F 21/00; H04L 9/32

(52) U.S. Cl. 726/6; 726/5; 713/155

(57) ABSTRACT

An approach for providing credibility information over an ad-hoc network is described. A trust manager receives content from a transmitting node over an ad-hoc network. The trust manager retrieves one or more trust values associated with the content, the transmitting node, or both, wherein the trust values are assigned by a trust server and further adjusted based on locally collected credibility information. The trust manager conducts a local evaluation of credibility information regarding the content, the transmitting node, or both. The trust manager then generates one or more combined trust values for the content, the transmitting node, or both from the trust values and the local evaluation.

### BACKGROUND

Service providers (e.g., wireless and cellular services) and device manufacturers are continually challenged to deliver value and convenience to consumers by, for example, providing compelling network services and advancing the underlying technologies. One area of interest has been the development of ad hoc networks for sharing information among the devices. However, because of the fluid nature of ad-hoc networks (e.g., devices may join or leave the ad-hoc network, thereby changing the network topology), service providers face technical challenges relating to assessing the credibility of information shared over the ad-hoc network and protecting privacy.

### Some Example Embodiments

Therefore, there is a need for an approach for efficiently providing credibility information over an ad-hoc network while protecting privacy.

According to one embodiment, a method comprises receiving content from a transmitting node over an ad-hoc network. The method also comprises retrieving one or more trust values associated with the content, the transmitting node, or both. The trust values are assigned by a trust server. The method further comprises conducting a local evaluation of credibility information regarding the content, the transmitting node, or both. The method further comprises generating one or more combined trust values for the content, the transmitting node, or both from the trust values and the local evaluation.

According to another embodiment, an apparatus comprising at least one processor, and at least one memory including computer program code, the at least one memory and the computer program code configured to, with the at least one processor, cause, at least in part, the apparatus to receive content from a transmitting node over an ad-hoc network. The apparatus is also caused to retrieve one or more trust values associated with the content, the transmitting node, or both. The trust values are assigned by a trust server. The apparatus is further caused to conduct a local evaluation of credibility information regarding the content, the transmitting node, or both. The apparatus is further caused to generate one or more combined trust values for the content, the transmitting node, or both from the trust values and the local evaluation.

According to another embodiment, a computer-readable storage medium carrying one or more sequences of one or more instructions which, when executed by one or more processors, cause, at least in part, an apparatus to receive content from a transmitting node over an ad-hoc network. The apparatus is also caused to retrieve one or more trust values associated with the content, the transmitting node, or both. The trust values are assigned by a trust server. The apparatus is further caused to conduct a local evaluation of credibility information regarding the content, the transmitting node, or both. The apparatus is further caused to generate one or more combined trust values for the content, the transmitting node, or both from the trust values and the local evaluation.

According to another embodiment, an apparatus comprises means for receiving content from a transmitting node over an ad-hoc network. The apparatus also comprises means for retrieving one or more trust values associated with the content, the transmitting node, or both. The trust values are assigned by a trust server. The apparatus further comprises means for conducting a local evaluation of credibility information regarding the content, the transmitting node, or both. The apparatus further comprises means for generating one or more combined trust values for the content, the transmitting node, or both from the trust values and the local evaluation.

According to another embodiment, a method comprises collecting credibility information regarding content transmitted by nodes operating over an ad-hoc network. The method also comprises generating trust values corresponding to the content, the nodes, or both based, at least in part, on the credibility information. The method further comprises causing, at least in part, actions that result in transmission of the trust values to at least one of the nodes. The nodes use the trust values in combination with local evaluations of the credibility information to generate combined trusts values for the content, the nodes, or both.

According to another embodiment, an apparatus comprising at least one processor, and at least one memory including computer program code, the at least one memory and the computer program code configured to, with the at least one processor, cause, at least in part, the apparatus to collect credibility information regarding content transmitted by nodes operating over an ad-hoc network. The apparatus is also caused to generate trust values corresponding to the content, the nodes, or both based, at least in part, on the credibility information. The apparatus is further caused to initiate actions that result in transmission of the trust values to at least one of the nodes. The nodes use the trust values in combination with local evaluations of the credibility information to generate combined trusts values for the content, the nodes, or both.

According to another embodiment, a computer-readable storage medium carrying one or more sequences of one or more instructions which, when executed by one or more processors, cause, at least in part, an apparatus to collect credibility information regarding content transmitted by nodes operating over an ad-hoc network. The apparatus is also caused to generate trust values corresponding to the content, the nodes, or both based, at least in part, on the credibility information. The apparatus is further caused to initiate actions that result in transmission of the trust values to at least one of the nodes. The nodes use the trust values in combination with local evaluations of the credibility information to generate combined trusts values for the content, the nodes, or both.

According to yet another embodiment, an apparatus comprises means for collecting credibility information regarding content transmitted by nodes operating over an ad-hoc network. The apparatus also comprises means for generating trust values corresponding to the content, the nodes, or both based, at least in part, on the credibility information. The apparatus further comprises means for causing, at least in part, actions that result in transmission of the trust values to at least one of the nodes. The nodes use the trust values in combination with local evaluations of the credibility information to generate combined trusts values for the content, the nodes, or both.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of providing credibility information over an ad-hoc network, according to one embodiment;

FIG. 2 is a diagram of the components of a trust server, according to one embodiment;

FIG. 3 is a diagram of the components of a trust manager, according to one embodiment;

FIG. 4 is a flowchart of a process for assessing credibility of content received at a node of the ad-hoc network, according to one embodiment;

FIG. 5 is a flowchart of a process for generating a trust value at a node of the ad-hoc network, according to one embodiment;

FIG. 6 is a flowchart of a process for generating trust values at a trust server, according to one embodiment;

FIG. 7 is a time sequence diagram that illustrates a sequence of messages and processes for providing credibility information over an ad-hoc network, according to one embodiment;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., a handset) that can be used to implement an embodiment of the invention.

### DESCRIPTION OF SOME EMBODIMENTS

Examples of a method, apparatus, and computer program for providing credibility information an ad-hoc network are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term “ad-hoc network” refers to a collection of autonomous nodes or terminals that communicate with each other by forming, for instance, a multi-hop network and maintaining connectivity in a decentralized manner. Each node of an ad-hoc network functions as both a host and a router. More specifically, the network topology of an ad-hoc network is generally dynamic, because the connectivity among the nodes may vary with time due to node departures, new node arrivals, and the mobility of nodes. Examples of ad-hoc networks include Mobile Ad Hoc Networks (MANETs) and Smart Sensor Networks (SSNs). Although various embodiments are described with respect to ad-hoc networks, it is contemplated that the approach described herein may be used with other type of communication network.

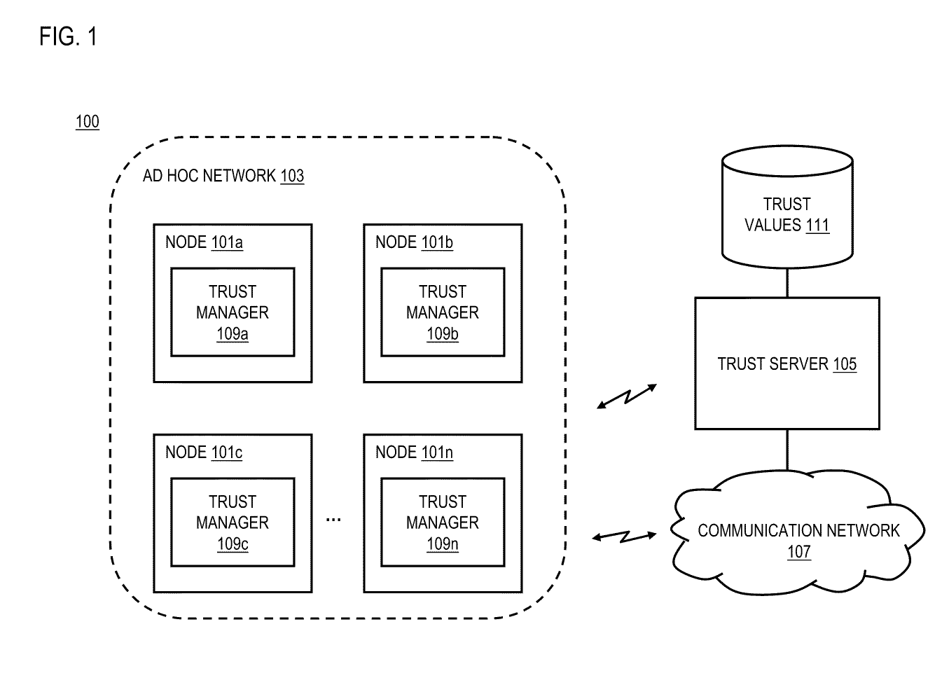

FIG. 1 is a diagram of a system capable of providing credibility information over an ad-hoc network, according to one embodiment. As discussed above, ad-hoc networks represent an emerging paradigm of networks offering unrestricted mobility of the participating nodes without any underlying infrastructure. When implemented in ubiquitous devices (e.g., cellular handsets, smartphones, mobile terminals, etc.) as the nodes, ad-hoc networks can achieve penetration into wherever the nodes exist or travel. The potentially vast coverage area provided by such mobile ad-hoc networks make them particularly attractive as the basis of content sharing services. By way of example, a node of the ad-hoc network may broadcast a query or request for specific content or information to neighboring nodes who may then respond (e.g., if the neighboring node has the requested information) or forward the request to yet other neighboring nodes. In this way, the information request can be quickly propagated throughout the ad-hoc network until the request finds the neighboring node that has the information or content for responding. This method of content sharing leverages the vast stores of information available from the nodes of an ad-hoc network.

However, the process of distributed or decentralized information sharing within an ad-hoc network faces significant technical challenges of how to determine the credibility of information obtained over the network (i.e., how does a receiving node know that the information it has received can be trusted). As used herein, credibility is a synonym for believability. That is, if an object (e.g., information, content, network node) has credibility, that credibility is a positive signal of the trustworthiness of the object. Credibility, for instance, provides a reason to trust the object. By way of example, conventional approaches to credibility management over a network (e.g., eBay feedback system, Amazon.com) rely primarily on a reputation system which relies on participating users to provide ratings of some content or other user. The ratings are then used to generate a corresponding reputation that is evidence of the credibility of the content or user. This type of reputation system, however, is vulnerable additional problems such as ratings or reputation manipulation through ratings retaliation by users who receive poor ratings, as well as the problem of connivance to artificially inflate or deflate reputations.

For ad-hoc networks, the reputation system generally is implemented in a distributed manner in which individual nodes are responsible solely for performing credibility evaluations. However, the problems of potential ratings or reputation manipulation remain. Furthermore, the lack of privacy or anonymity in the reputation system enables potential attacks such as “bad mouthing” attacks whereby a collection of nodes may coordinate to give a falsely negative rating to specific nodes. Conversely, the mischievous nodes may also target specific nodes to give unwarranted positive ratings. These potential problems may discourage users from using content services over ad-hoc networks because the credibility of information cannot be reliably obtained.

Furthermore, within an ad-hoc network, such a reputation system faces the added technical challenge of how to correlate reputation information with nodes that operate anonymously. For example, it is noted that one of the main tenets of ad-hoc networks is that nodes share information anonymously. This anonymity protects the privacy so that the shared information may not be used to uniquely identify any other node. Implementing a conventional distributed reputation system in an ad-hoc network would break this anonymity because the nodes must be able to uniquely identify a transmitting node to determine its credibility. Otherwise, the reputation system would have limited effectiveness because the nodes could not be uniquely identified.

To address this problem, the system 100 of FIG. 1 introduces the capability to generate trust values that are associated with content and/or nodes operating over the ad-hoc network both at a centralized server and locally at the node. As shown in FIG. 1, the system 100 comprises a plurality of nodes (e.g., nodes 101a-101n) within an ad-hoc network 103 within connectivity to a trust server 105 via a communication network 107 or directly via the ad-hoc network 103. The nodes 101a-101n further include, respectively, trust managers 109a-109n that interact with the trust server 105 to generate trust values that can be stored either in the database 111 of trust values and/or within the trust managers 109a-109n or the trust server 105. In one embodiment, it is contemplated that the database 111 and or other components of the system 100 storing the trust values and related credibility information can employ secure storage mechanisms (e.g., authentication, encryption, etc.) to ensure that only authorized users or nodes 101 may access in the information.

In one embodiment, the trust value (e.g., indicator of credibility) is a combined trust value including two parts: (1) a first part of the trust value provided by the server 105 that assesses the historical performance and behaviors of a transmitting node 101 (e.g., historical reliability of communication transmissions and content recommendations), and (2) a second part of the trust value evaluated at a local node 101 based on recent experience (e.g., content recommendations, ratings, etc. received at the node 101) with the transmitting node 101. This hybrid approach advantageously enables the system 100 to track historical performance of a particular node 101 at the trust server 105 over a longer period of time so that any ratings spikes caused by mischievous ratings manipulation can be normalized over the longer time period, while at the same time enabling weighting of more recent experiences with the transmitting node 101 based on the local evaluation conducted at the node 101.

Additionally, to enhance privacy, the trust server 105 may frequently and/or periodically issue new anonymous identifiers to the nodes 101 within the ad-hoc network 103 to make it more difficult to track information (e.g., content, queries, credibility information, etc.) corresponding to any particular node 101. For example, the local experience is accumulated only based on the most recent valid anonymous identifier. Therefore, any node 101 that is tracking the credibility of another node 101 would not be able to link any credibility information associated with the tracked node 101 when the anonymous identifier associated with the tracked node 101 is changed. In one embodiment, historical trust evaluation on the node 101 being tracked is performed by the trust server 105 by collecting, for instance, all communication and content recommendation information related to the tracked node 101 using all of the multiple anonymous identifiers associated with the tracked node 101.

In one sample use case, a querying node 101a receives content or content recommendations from a transmitting node 101b. The trust manager 109a of the querying node 101a calculates the trust value of the received content based on, for instance: (1) an identifier of the content; (2) a trust value of the transmitting node 101b; (3) ratings of the content provided by other nodes 101c-101n; (4) trust values of the other nodes 101c-101n providing the ratings; (5) the number of times the content has been transmitted or recommended (e.g., an indicator of the popularity of the content); and (6) a local evaluation of credibility information associated with the transmitting node 101b, the other nodes 101c-101n, and the route (e.g., relaying nodes) along which the content was transmitted to the querying node 101a. Then, the user associated with the querying node 101a can use the trust values to decide whether and how to use the received content or content recommendations.

In certain embodiments, the trust server 105 is applied to collect feedback ratings on the nodes 101 and the content shared among them. The trust server 105 can also collect node interaction statistical data which can be combined with the feedback information to generate and issue trust certificates (e.g., trust values) to the nodes 101. This trust certificate is, for instance, a part of the credibility information used to generate the overall or combined trust value for the content and/or the nodes 101 that transmitted the content. In one embodiment, because the system 100 uses periodically changing anonymous identifiers, only the trust server 105 knows the actual identifier associated with the ad-hoc node 101b. All other entities (e.g., other nodes 101) know only the anonymous identifier. Thus, it is possible for the trust server 105 to evaluate the trust value for the node 101b in an accurate way based on past history. The node trust evaluation at the trust server 105 is based, at least in part, on two kinds of history: (1) ad hoc communication behavior (e.g., reliability of the node 101's physical transmissions such as the percentage of successful message transmissions) and (2) content recommendation behavior such as the percentage of useful or effective content or content recommendations made by a particular node 101. In certain embodiments, the trust server 105 may also issue a “black list” of malicious nodes 101 and a “favorite list” of honest active nodes 101 according to the trust evaluation results.

Meanwhile, the trust server 105 can also generate reputation or trust values of various contents based on, for instance, the feedback of the nodes 101 and content recommendation history reported by the nodes 101. In one embodiment, these reputation values can be used for other services or applied as an important factor to assess the trust value of the node 101. All above mentioned trust or reputation values are dynamically evolved as new experiences are accumulated. In other words, the trust evaluation of the nodes, contents, ratings, etc. is iterative.

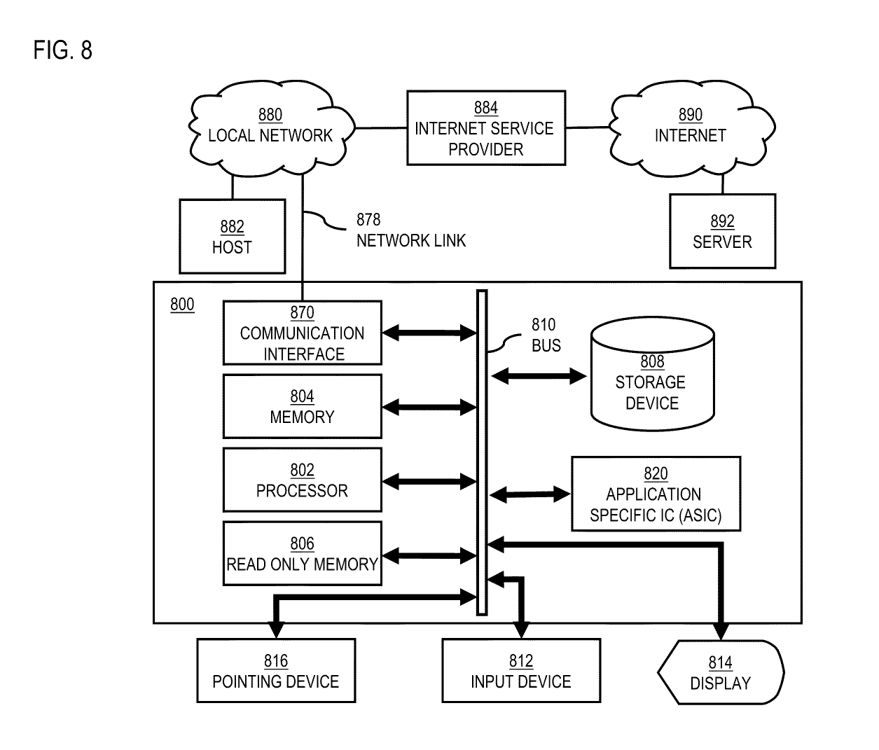

In one embodiment, the trust server 105 and the trust managers 109a-109n can be implemented via shared, partially shared, or different computer hardware (e.g., the hardware described with respect to FIG. 8).

By way of example, the communication network 107 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, mobile ad-hoc network (MANET), smart sensor network (SSN), and the like.

The node 101 is any type of mobile terminal, fixed terminal, or portable terminal including a mobile handset, station, unit, mobile device, mobile telephone, multimedia tablet, Internet node, communicator, desktop computer, laptop computer, Personal Digital Assistants (PDAs), or any combination thereof. It is also contemplated that the nodes 101a-101n can support any type of interface to the user (such as “wearable” circuitry, etc.).

By way of example, the nodes 101a-101n and the trust server 105 communicate with each other and other components of the communication network 107 using well known, new or still developing protocols. In this context, a protocol includes a set of rules defining how the network nodes within the communication network 107 interact with each other based on information sent over the communication links. For example, communication between the node 101 and the trust server may be conducted using hypertext transfer protocol secure (HTTPS) protocol, and communication among the nodes 101 can use transport layer security (TLS) protocol over wireless local area network (WLAN), Bluetooth, or other short range radio technology. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

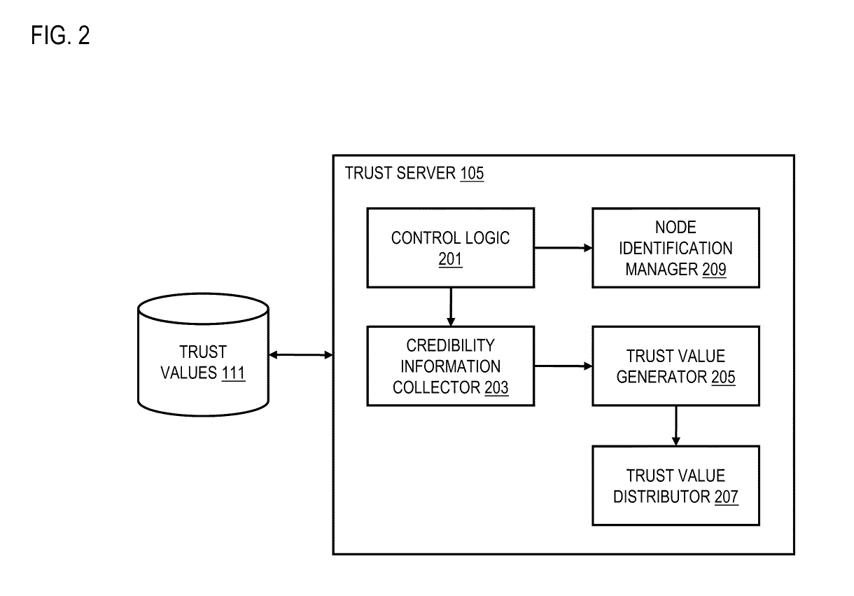

FIG. 2 is a diagram of the components of a trust server, according to one embodiment. By way of example, the trust server 105 includes one or more components for generating a trust value associated with content and/or the node 101 that transmitted the content. It is contemplated that the functions of these components may be combined in one or more components or performed by other components of equivalent functionality. In this embodiment, the trust server 105 includes at least a control logic which executes at least one algorithm for executing the functions of the trust server 105. For example, the control logic 201 interacts with the credibility information collector 203 to collect credibility information regarding content transmitted by the nodes 101 operating over the ad-hoc network 103. In one embodiment, as the nodes 101 request or transmit content over the ad-hoc network 103, the nodes 101 report the communication conditions and content information to the credibility information collector 203. The communication conditions, for instance, may specify whether the node 101 has successfully transmitted a query, transmitted a response to a query, forwarded a query, or performed other similar content sharing action. The content information relates to content shared, recommended, queried, or provided as responses to queries, and includes, for instance, rating information about the content, usage information, recommendation information, etc. The credibility information is saved to, for instance, the trust values database 111, which also includes the trust values (e.g., reputation information), trust certificates of each node 101, and real node identifier with corresponding anonymous identifiers as described below. As discussed previously, the database 111 can store information using secure storage technology including data encryption (e.g., BitLocker encryption via a Trusted Platform Module, TrueCrypt encryption, and the like) and/or authentication mechanisms (e.g., biometric security, user name/password combination, network address filtering, and the like). It is contemplated that the database 111 and other databases in the system 100 may operate using any secure storage technology to prevent unauthorized access to the stored data.

After collecting credibility information, the control logic 201 interacts with the trust value generator 205 to generate trust values corresponding to the content and/or the transmitting nodes 101, as well as other nodes 101 (e.g., relaying nodes 101) that may have been part of the communication route used to transmit the content. As described earlier, the trust value generation process is an iterative process that occurs as new credibility information is collected. In one embodiment, the trust value generation process may more heavily weight more recent credibility information so that more recent behavior of the node 101 can have a greater effect on the trust value. In this way, the trust value can more accurately reflect the latest behavior trend of the node 101. In addition, the trust value generator may use advanced trust modeling technology (e.g., as described in Z. Yan (ed.), “Trust Modeling and Management in Digital Environments: from social concept to system development, IGI Global, 2009, incorporated herein by reference in its entirety) to identify malicious nodes 101 as well as honest nodes 101. By way of example, the trust modeling technology can employ cluster filtering and/or collaborative filtering to identify malicious or honest nodes 101. The trust value generator may store the generated trust values as trust certificates in the trust values database 111. The trust value distributor 207 then distributes the trust certificate of each node 101, as well as content trust (e.g., reputation) values to each node 101 periodically or by request.

As shown in FIG. 2, the control logic 201 also interacts with the node identification manager 209 to handle ad-hoc node 101 registration as the node 101 enters, leaves, or moves within the ad-hoc network 103. In addition, the node identification manager 209 identifies and stores (e.g., in the database 111) the real identifier associated with each node 101 and periodically assigns each node 101 a new anonymous identifier. In one embodiment, the real identifier is known only to the trust server 105; all other interactions of the node 101 within the ad-hoc network 103 are associated with an anonymous identifier to protect the privacy of the node 101.

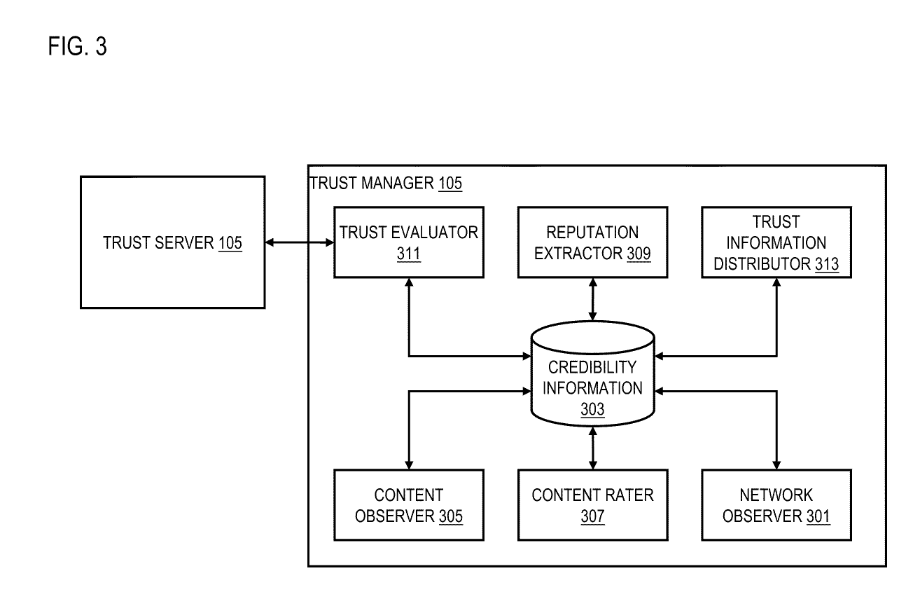

FIG. 3 is a diagram of the components of a trust manager, according to one embodiment. By way of example, the trust manager 109 includes one or more components for generating, at the node 101, a trust value associated with content and/or the node 101 that transmitted the content from historical credibility information or data. It is contemplated that the functions of these components may be combined in one or more components or performed by other components of equivalent functionality. For example, a network observer 301 records communication flow and content recommendation flows within the portion of the ad-hoc network 103 visible to the network observer 301 (e.g., among neighboring nodes 101). The communication flow includes transmissions of queries, forwarded queries, and the like that are visible to the node 101 executing the network observer 301. Content recommendation flow includes responses to the queries (e.g., responses specifying content or content recommendations) received at or visible to the node 101 executing the network observer 301. In one embodiment, the network observer 301 stores information related to the observed communication and content recommendation flows in, for instance, the database 303 of credibility information.

A content observer 305 then works with the network observer 301 to monitor the usage history of content received at the node 101 or observed in the content recommendation flow. By way of example, the content observer 305 uses the usage history to generate a profile of the real usage behavior of the nodes 101 in the ad-hoc network 103 with respect to the observed content. For example, if the content is an application, the real usage behavior may track whether the application has been installed and/or used/consumed at the node 101. If the content is a link (e.g., a uniform resource locator (URL) link), the content observer 305 may observe the number of times the link is accessed. In one embodiment, usage behavior is a quantitative measure of the user's trust in the content or content recommendation that can be used as one factor in generating a trust value associated with the content (e.g., a trust cue to indicate that the content can be trusted). Accordingly, the usage behavior can be reported to the trust server 105 for use in generating a trust value associated with the content and/or the node 101 transmitting the content.

On receipt or use of the content, the content rater 307 provides a user interface for the user associated with the node 101 to recommend and/or rate content to other nodes 101 and/or to the trust server 105. The recommendation and/or rating may simply ask the user whether the content was useful or not useful. In other embodiments, the rating system may be more elaborate with multiple categories (e.g., usefulness, accuracy, completeness, etc.) rated on a scale with more granularity (e.g., a scale from 1 to 10). The recommendations and ratings are stored in the credibility information database 303 using, for instance, secure storage technology. At the same time, the reputation extractor 309 retrieves credibility information (e.g., trust values, trust certificates) associated with the content and/or the transmitting and relaying nodes 101 from the trust server 105. The credibility information retrieved from the trust server 105 represents a historical evaluation of the credibility or trustworthiness of the corresponding content and/or node 101. The reputation extractor 309 stores the received credibility information in the database 303 for retrieval by the trust evaluator 311.

In one embodiment, the trust evaluator 311 of the trust manager 109 combines the credibility information retrieved from the trust server 105 with an independent trust evaluation of the content and/or nodes 101 conducted locally, for instance, at the node 101 receiving the content. By way of example, the trust evaluator 311 creates a trust value for the content by combining factors such as the content usage behavior described above with information on the user's behavior that reflect on the performance or effectiveness of the content (e.g., “reflection behavior”) as well as information of the user's behavior correlated to similar or analogous content (e.g., “correlation behavior”). In one embodiment, reflection behavior is determined by monitoring user behavior after the user has either a good or a bad experience with the content (e.g., confronts a problem with the content). For example, if a user has a good experience with the content, the user may be more likely to use the content in risky, urgent, or important tasks. Therefore, reflection behavior that is expressed as frequency of use of the content for risky, urgent, or important can one factor in generating a trust value.

In another embodiment, correlation behavior can be determined by monitoring user behavior when the user has access to equivalent or analogous content. For example, a higher usage rate (e.g., usage time, number of usages, and frequency of use) of one content over other equivalent or analogous content indicates the user's trust in the chosen content. Correlation behavior can also be determined by monitoring how often the user recommends the content over other equivalent content. It is noted that the act of recommending a particular content is an example of correlation behavior that indicates trust (e.g., the user is likely to recommend only those content that the user trusts). Therefore, correlation behavior can be another factor in generative a trust value.

In the system 100, it is contemplated that because of the periodically changing anonymous identifiers used in the approach described herein, the trust evaluator 311 will have access to a smaller set of credibility information than the trust server 105. For example, the trust evaluator 311, at the local level, will be able to associate observed credibility information with another node 101 only to the point when the anonymous identifier associated with the tracked node 101 last changed. This is because, unlike the trust server 105 (e.g., which has to the real identifier associated with each node 101), the trust evaluator 311 will not be aware of that a node 101 has been assigned a new anonymous identifier. To the trust evaluator 311, the same node 101 with a new anonymous identifier looks like a different node 101. The advantage of such an approach is that privacy of the nodes 101 can be better protected. Furthermore, the local evaluation can provide an indicator of a more current trust level or reputation of a tracked node 101 in that the local evaluation does not account for historical information.

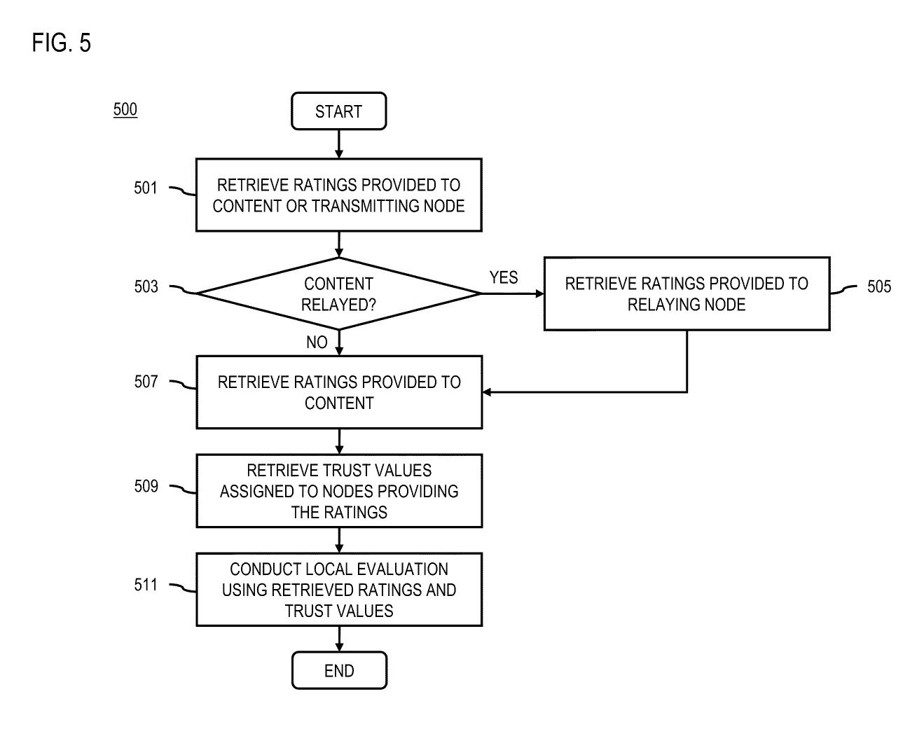

For example, an example ad-hoc network 103 is configured to change the anonymous identifiers of the nodes operating within the network 103 once every three hours. Accordingly, the trust evaluator 311 will have access to only the credibility information observed during the most recent three hour period. It is noted that the trust server 105 is not subject to this limitation because the trust server 105 has knowledge of both the real identifiers and corresponding multiple anonymous identifiers associated with any particular node 101. Therefore, the approach described herein leverages the historical credibility information collected at the trust server 105 with the more recent local evaluation of credibility information of the trust evaluator 311 to generate an overall or combined trust value. To this end, the trust evaluator 311 generates the overall or combined trust value for the content and/or nodes by using an algorithm (e.g., discussed in more detail with respect to FIG. 5 below) that combines the local evaluation with the trust values generated by the trust server 105. The trust information distributor 313 can then report the results of the local evaluation, the observed communication flows, and/or the observed content recommendation flows to the trust server 105.

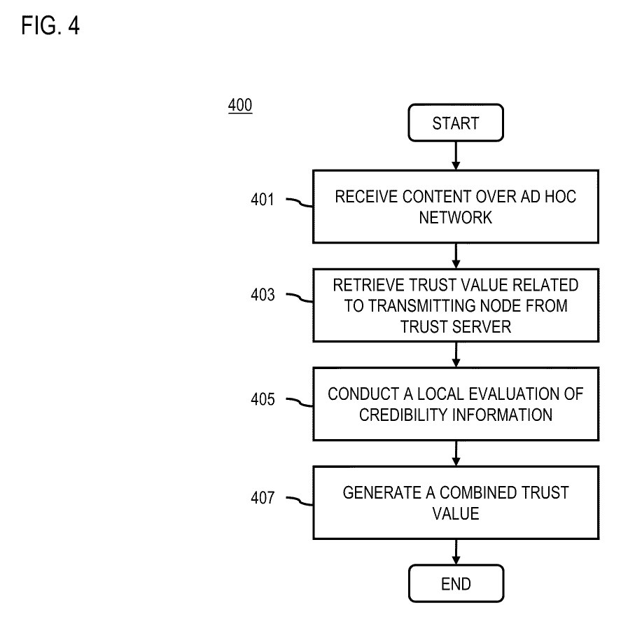

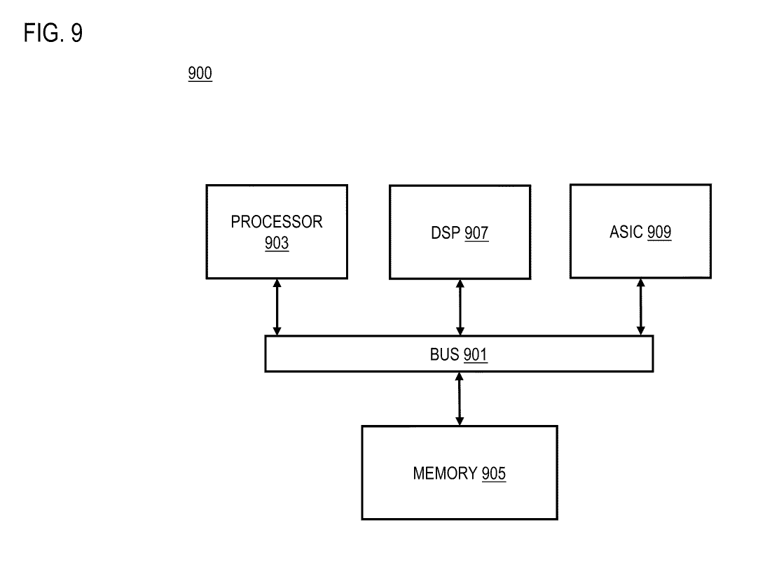

FIG. 4 is a flowchart of a process for assessing credibility of content received at a node of the ad-hoc network, according to one embodiment. In one embodiment, the trust manager 109 performs the process 400 and is implemented in, for instance, a chip set including a processor and a memory as shown in FIG. 9. In step 401, the trust manager 109 or the node 101 in which the trust manager 109 is executed receives content over the ad-hoc network 103. This content, for example, may be received in response to a query for information broadcast over the ad-hoc network 103. In one embodiment, the content may be received using short-range radio technology (e.g., WLAN and Bluetooth) over the ad-hoc network 103.

Next, the trust manager 109 retrieves the trust value (e.g., trust certificate) associated with the transmitting node 101 from the trust server 105 (step 403). In certain embodiments, the trust value may also be included in the content message as a trust certificate or token issued or signed by the trust server 105. For example, the trust certificate may contain the anonymous identifier associated the with transmitting node 101, a trust value for the node 101 generated by the trust server 105, and a period time during which the trust certificate is valid. In this way, the trust manager 109 may still obtain the trust value even when a connection to the trust server 105 is unavailable by extracting the trust value from the trust certificate. As discussed earlier, the trust certificate provides an indicator of the credibility or trustworthiness of the transmitting node 101. In addition or alternatively, the trust certificate may be provided with the content by the transmitting node itself. The trust certificate includes, for instance, the anonymous identifier associated with the transmitting node, a trust value associated with the node 101 that is generated by the trust server 105, and a validity period for the trust certificate. The validity period typically may coincide with the frequency at which the trust server 105 issues new anonymous identifiers to the nodes 101. In certain embodiments, the trust manager 109 may also retrieve trust certificates related to the content itself or to other nodes 101 that have relayed the content along a communication route from the transmitting node 101 to the receiving node 101.

The trust manager 109 also conducts a local evaluation of the credibility information (e.g., communication flows, content recommendation flows, content ratings, etc.) received or observed directly at the node 101 (step 405). This local evaluation, for instance, enables trust manager to supplement the trust values provided by the trust server 105 with local observations to more accurately represent the trust value of the content and/or the transmitting node 101. Accordingly, the trust manager applies a trust value algorithm (e.g., as described with respect to FIG. 5 below) to combine the trust certificate of the trust server 105 with the local observations or evaluations of the corresponding credibility information associated with the transmitting node 101. The combination results in the generation of an overall or combined trust value associated with the content and/or transmitting node 101 (step 407). In one embodiment, the receiving node 101 can then use this combined trust value to evaluate, for instance, whether or how to use the received content.

In one sample use case scenario, a node 101a of the ad-hoc network 103 sends a query to its neighboring nodes 101b-101n about a nearby restaurant (e.g., in a football stadium). The neighboring nodes 101b-101n (e.g., those within the football stadium) may further distribute the query to yet other nodes 101 (e.g., those beyond the football stadium) via broadcast or multicast. On receiving the query, one or more of the neighboring nodes 101b-101n respond with content providing feedback about, for example, the nearby restaurant. The trust manager 109 of the querying node 101a processes all of the receive content (e.g., responses) and calculates a trust value for each of the received responses to assist the user of the querying node 101 on deciding whether to eat at the nearby restaurant. After consuming the content, the node 101a provides feedback to the trust server 105 by rating the content and reporting each content and recommending node 101's communication flows (e.g., quality of physical transmissions, successful message forwarding, etc.) and content recommendations. Thus, the trust server 105 can evaluate each content's trustworthiness based on the reported credibility information.

In addition or as an alternative to the process 400, it is contemplated that the trust manager 109 may use any other process or algorithm for assessing the credibility of content and/or the node 101 that transmitted the content. For example, the trust manager 109 may generate trust values based on a combination of usage behavior, reflection behavior, and/or correlation behavior as discussed above. FIG. 5 below provides one example process or algorithm.

FIG. 5 is a flowchart of a process for generating a trust value at a node of the ad-hoc network, according to one embodiment. In one embodiment, the trust manager 109 performs the process 500 and is implemented in, for instance, a chip set including a processor and a memory as shown in FIG. 9. The process 500 describes the local evaluation process for generating a combined trust value as discussed with respect to the process 400 of FIG. 4. The process 500 assumes that the trust manager 109 or the node 101 executing the trust manager 109 has already received content over the ad-hoc network 103. In step 501, the trust manager 109 retrieves ratings provided to the node 101 that transmitted the content. The ratings information for the transmitting node 101 represents evaluations by other nodes 101 that have communicated with the transmitting node. This ratings information may grade the overall reliability, communications quality, content recommendation quality, and the like associated with the transmitting node. In one embodiment, the ratings information may be embedded in the content or in metadata associated with the content. In addition or alternatively, the trust manager 109 may query neighboring nodes 101 or the trust server 105 for the ratings information.

Next, the trust manager determines whether the communication route along which the content was transmitted include any relaying nodes 101 (step 503). For example, the transmitting node 101 may be located at a sufficiently far distance from the receiving node 101 that a direct transmission from the transmitting node 101 was not possible. In this case, the content is relayed through one or more relaying nodes 101 between the transmitting and receiving nodes 101. If there are such relaying nodes 101 along the communication route, the trust manager 109 retrieves ratings information associated with each relaying node 101 as well (step 505).

After obtaining ratings information about the nodes 101 (e.g., transmitting and relaying nodes), the trust manager 109 also obtains ratings information about the content if available (step 507). For example, in many cases the same content may have been provided in response to queries by other nodes 101 in the ad-hoc network 103. These other nodes 101 then may provide ratings information for the content. As with the node ratings information, the content ratings information may be included in the content or metadata associated with the content. The content ratings information may also be retrieved from the trust server 105 or the neighboring nodes 101 directly.

In step 509, the trust manager 109 retrieves the trust values from the trust server 105 for the nodes 101 that have provided either the node or content ratings information. In this way, the trust manager 109 can assess the credibility of the nodes that are providing the ratings as a measure of the credibility of the ratings. As a result, the trust manager 109 is more likely to detect potential ratings manipulation when compared to conventional approaches which do not account for the reliability of the rating nodes 101. In one embodiment, the trust manager 109 may also perform a local evaluation of ratings related to the nodes 101 providing the first set of ratings. In other words, the trust evaluation process may be performed recursively to assess different layers of credibility information and ratings. After obtaining the ratings information and trust values, the trust manager 109 employs, for instance, an trust evaluation algorithm that aggregates at least the following factors together: (1) ratings of the transmitting and relaying nodes; (2) trust values (e.g., trust certificates) corresponding to the nodes 101 providing the ratings; (3) popularity of the content or content recommendation, e.g., obtained by counting the number of times the content is transmitted or used over the ad-hoc network 103; and (4) local evaluation of the transmitting nodes 101 and the communication routes over which the content is transmitted. In one embodiment, this aggregation represents a combined or overall trust value associated with the content and/or transmitting node 101. In another embodiment, it is contemplated that the trust manager 109 may adjust the weighting of the individual factors to generate combined or overall trust values that emphasizes one or more factors over other factors.

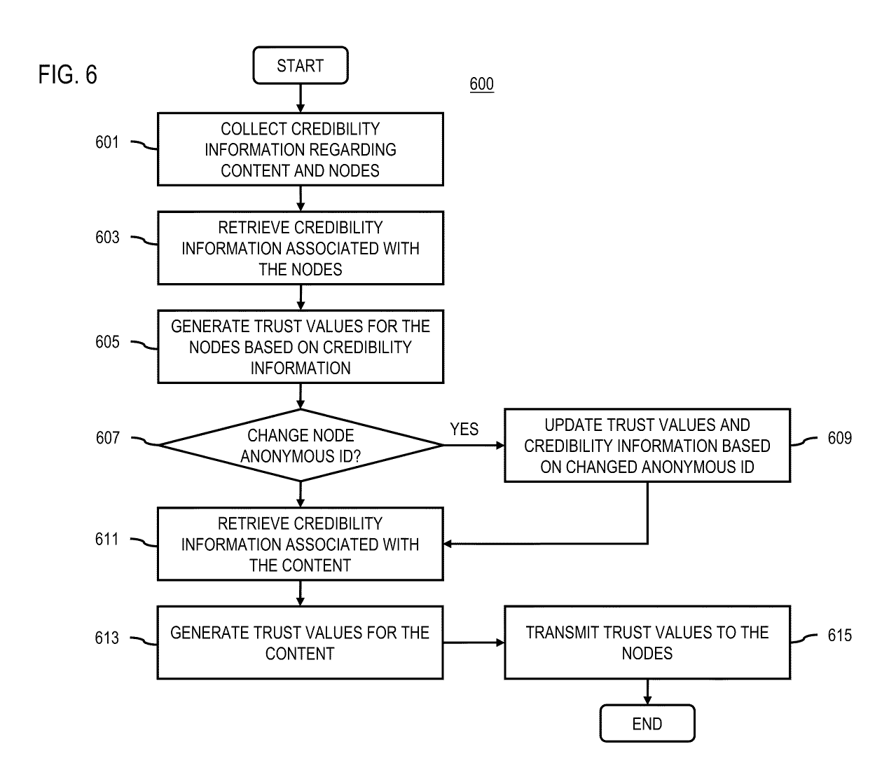

FIG. 6 is a flowchart of a process for generating trust values at a trust server, according to one embodiment. In one embodiment, the trust server 105 performs the process 600 and is implemented in, for instance, a chip set including a processor and a memory as shown in FIG. 9. In step 601, the trust server 105 collects credibility information regarding content and nodes operating over the ad-hoc network 103. The credibility information, for instance, is reported to the trust server 105 as content is shared over the network 103. For example, when a querying node 101 receives content, the node 101 consumes the content and provides a corresponding rating of the content and/or the node 101 that transmitted or recommended the content. In addition, the node 101 may report the communication flows and content recommendation flows observed at the node 101.

From this collected credibility information, the trust server 105 retrieves records related to the credibility of a particular node (step 603). Such records include, for instance: (1) historical communication flow statistical records (e.g., the number of successful ad-hoc messages forwarded by the node 101, the number of unsuccessful ad-hoc messages forwarded by the node 101); (2) historical content recommendation flow records (e.g., number of useful content recommendations, number of unuseful content recommendations, deviations of content recommendation/rating value with the aggregate content trust (e.g., reputation) value, and the like); and (3) the time of the records were collected. For example, the trust server 105 can weigh more recent records or experiences with the node 101 more heavily in generating a trust value for the node 101. The trust server 105 then applies a trust evaluation algorithm that considers the records listed above to generate the trust value for with the node 101 (step 605). In one embodiment, the algorithm considers each factor equally to generate a trust value. In addition or alternatively, the algorithm may provide different weighting for each factor.

As discussed previously, the trust server 105 may be configured to periodically change the anonymous identifiers associated with each node 101 to protect the privacy of the nodes 101 over the ad-hoc network 103. Accordingly, the trust server 105 determines whether the validity period for the anonymous identifiers corresponding to each node 101 is within a predetermined period of time from expiring. If so, the trust server 105 determines whether to issue new anonymous identifiers based on the pending expiration (step 607). Once the anonymous identifiers are changed, the trust server 105 updates the trust values and credibility information to associate them with the new anonymous identifier (step 609). In this way, the trust server 105 can maintain consistent historical records for each node even after the anonymous identifier of each node is changed. In one embodiment, this process of updating the records after changing the anonymous identifier is facilitated by maintaining a real or static identifier associated with each node 101. This static identifier is known only to the trust server 105 and not shared with other nodes 101 to protect privacy.

In step 611, the trust server 105 retrieves, from the collected credibility information, credibility information that is related specifically to the content. The content-related credibility information includes, for instance: (1) ratings of the content by users of nodes 101 receiving the content; (2) the time associated with the rating (e.g., more recent ratings are weighed more heavily); (3) the trust value or trust certificate associated with the nodes 101 providing the ratings; (4) usage data by the nodes 101 receiving the content (e.g., number of times the content was accessed or used); and (5) the number of ratings or recommendations provided for the content. The trust server 105 then applies a trust evaluation algorithm that considers the above factors to generate a trust value for the content (step 613). As with the algorithm for determine a trust value for a node 101, the algorithm may, for instance, consider each factor equally to generate a trust value. In addition or alternatively, the algorithm may provide different weighting for each factor. The trust server 105 then transmits the trust values generated for the nodes and/or the content to the nodes 101 of the ad-hoc network 103 (step 615). In one embodiment, the trust values are transmitted as trust certificates.

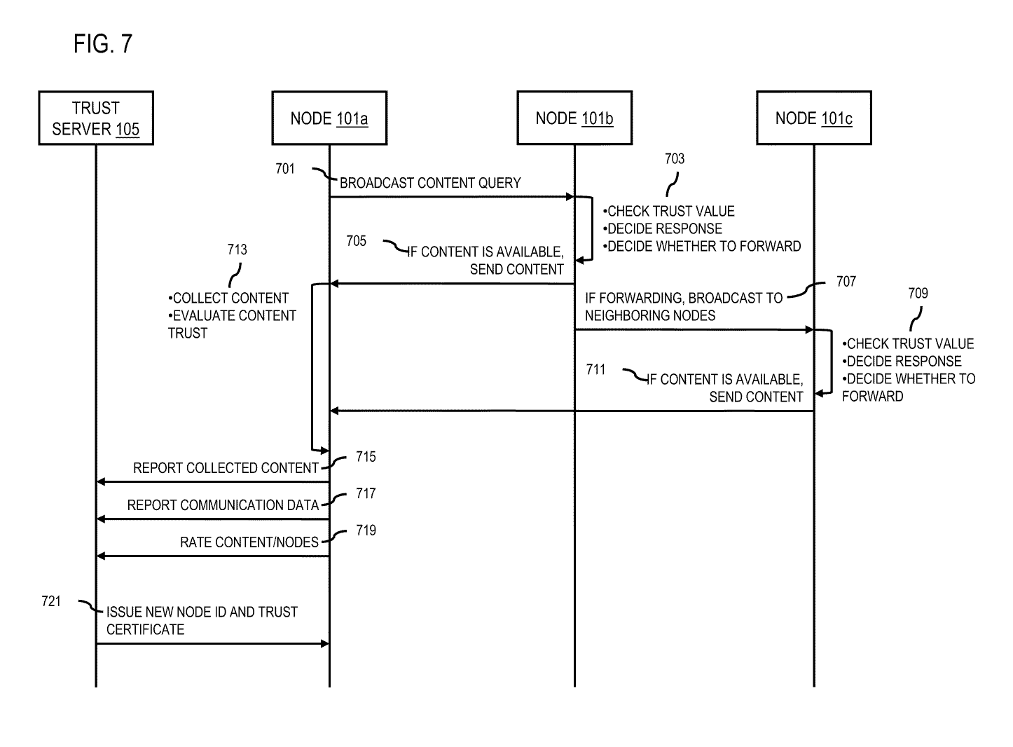

FIG. 7 is a time sequence diagram that illustrates a sequence of messages and processes for providing credibility information over an ad-hoc network, according to one embodiment. A network process on the network is represented by a vertical line capped with a descriptive box. A message passed from one process to another is represented by horizontal arrows. A step performed by a process is indicated by the text. The processes represented in FIG. 7 are the trust server 105 and the nodes 101a-101c which operate over the ad-hoc network 103 using the approach described herein for providing credibility information.

At 701, the node 101a (e.g., a querying node) broadcasts a content query over the ad-hoc network 103. By way of example, the query includes a query identifier, an anonymous identifier of the node 101a, and a trust certificate associated with the node 101a. The query identifier is a unique identifier that enables responding nodes to quickly and easily identify messages or responses related to the same query; the anonymous identifier uniquely identifiers the requestor over the network; and the trust certificate provides a measure of credibility that is determined by the trust server 105. In addition, the trust certificate may include the anonymous identifier associated with the node 101a, as well as, the trust value generated for the node 101a and the period during which the trust value is valid.

At 703, the node 101b receives the query from the node 101a via, for instance, broadcast or multicast. On receiving the query, the node 101b evaluates the trust certificate to determine whether the query is from a node that meets a trust value threshold predetermined by the node 101b. If the trust value of the node 101a meets the threshold, the node 101b determines whether it has the content requested by the query. If the trust value of the node 101a does not meet the threshold, the node 101b may assume that the node 101a is malicious and may not respond even though the node 101b may have the requested content.

If the requested content is available, the node 101b sends a response to the node 101a (at 705). The response includes, for instance, the query identifier, content identifier, content rating, anonymous identifier associated with the node 101b, and a trust certificate associated with the node 101b. The query identifier in the response matches the query identifier transmitted by the node 101a; the content identifier is the requested content or links to the requested content; the content rating are ratings provided to the content by other nodes that have received the content; and the anonymous identifier and trust certificate of the node 101b are the same as described with respect to the node 101a.

Returning to 703, the node 101b also determines whether to forward the query to other nodes (e.g., the node 101c) in the ad-hoc network 103. The node 101b may determine whether to forward the message based on monitoring communication flows among the neighboring nodes 101. For example, if the node 101b detects that multiple messages containing the same query identifier have already been transmitted to the node 101c, the node 101b need not forward the query. In addition, the mode 101b may determine whether to forward the query by checking trust certificate associated with the querying node 101a to determine whether the node 101a is malicious. If the trust value of the querying node 101a is below the predetermined threshold, the node 101b may not forward the query. Otherwise, the node 101b adds its anonymous identifier and trust certificate to the query and forwards the query to the node 101c via a broadcast message (at 707).

On receiving the query, the node 101c performs steps similar to the steps performed by the node 101b (at 709). For example, the node 101c checks the trust values contained in the query. In this case, the query now contains anonymous identifiers and trust certificates corresponding to both the querying node 101a and the forwarding node 101b. If the trust certificates of both of these nodes 101a-101b meet the minimum threshold defined by the node 101c, the node 101c can decide whether to respond and/or forward the query even further. If the node 101c contains content responsive to the query, the node 101c transmits the content to the node 101a (at 711).

At 713, the node 101a collects content received in responses from both the node 101b and the node 101c. In one embodiment, the node 101a accepts query responses for a predetermined period of time following the initial broadcast of the query. Because the query may be propagated throughout the ad-hoc network 103 at varying rates, potential responses may be received over a potentially broad period of time. After the predetermined period for collection has expired, the node 101a collects all received content and evaluates the trust value of each of the content received according to the process 400 of FIG. 5 and the process 500 of FIG. 4. Depending on the query and the number of responding nodes, the responses may be quite varied in quality and credibility.

Next, the node 101a reports all of the received content and/or content recommendations to the trust server 105 (at 715). The content report includes for instance, the content identifier, anonymous identifier of the transmitting node, and a trust certificate of the node. In addition, the node 101a reports related communication flows and data to the trust server 105 (at 717). The communication data include, for instance, communication routes and the success or failures of message forwarding and reply attempts. Finally, the node 101a rates each received content and reports the rating to the trust server 105 (at 719).

The trust server 105 collects and aggregates the newly reported with previously reported credibility information to generate an updated trust certificate for each of the nodes (e.g., the nodes 101a-101c) participating in the query based on the newly collected information. When the trust server 105 issues the new anonymous identifiers to the nodes 101a-101c (e.g., according to a predetermined schedule), the trust server 105 also transmits the corresponding updated trust certificates (at 721). In addition or alternatively, the trust server 105 may transmit the updated trust certificate on request from the corresponding node (e.g., the node 101a-101c).

The processes described herein provided a number of advantages over conventional approaches. First, the system 100 enhances the privacy of a node 101 operating over the ad-hoc network 103. More specifically, the anonymous identifier associated with each node 101 can be frequently changed without affecting the ability to maintain a credibility system. For example, the trust server 105 may issue a new anonymous identifier to each node 101 every few hours. Further, the system 100 provides a trust solution for content information distribution over an ad-hoc network 103 by considering the content rating's credibility in addition to the content rating itself. This content rating credibility is generated partially based on recent experience of the transmitting node 101 that is identified by its frequently changing anonymous identifier as well as an aggregated value evaluated at the trust server 105 that includes the full history of credibility information identified by the real identifier (e.g., the non-changing but protected identifier) associated with the node 101. Only the trust server 105 has the knowledge of the real identifier associated with the node 101. All other components of the ad-hoc network 103 only have the knowledge of the constantly changing anonymous identifier. Thus, the privacy of the node 101 is protected by making it difficult to track the node based on content recommendation and communication data shared over the ad-hoc network 103.

Another advantage of the system 100 is that the trust values generated by the system is based on both a centralized (e.g., trust server 105) evaluation and a distributed (e.g., local node) evaluation of the credibility information to provide a combined or overall credibility evaluation. Unlike conventional approaches, the trust values are generated based on both the local node's recent experiences with the recommender nodes and the trust server 105's historical evaluation of the nodes. This hybrid approach minimizes the potential impacts of malicious ratings manipulation. For example, transient malicious ratings are quickly eliminated from consideration at the local level when anonymous identifiers are changed and previous credibility histories are discarded in the local evaluations. At the same time, the any spike in ratings differences is normalized by the historical context provided by the trust server 105's trust evaluations.

Another advantage of the system 101 is the reduction of energy consumption for conducting trust evaluations over an ad-hoc network 103. It is noted that mobile devices (e.g., mobile telephones) operating over the ad-hoc network 103 have limited power supplies. Therefore, it is advantageous to provide any possible power saving options. Under the approach described herein, the device-to-device communication times for trust evaluation is greatly reduced compared to conventional approaches that require extensive communications among nodes in order to calculate one node's reputation or trustworthiness. Herein, the system 100 applies the trust server 105 to calculate a node's reputation or trust value and to provide the trust value to each node. It is recognized that generally this server-to-device communication consumes much less energy that device-to-device communication. Thus, the system 100 greatly reduces the power consumption of mobile devices operating over the ad-hoc network 103.

Yet another advantage of the system 100 is that the use of a centralized trust server 105 enables potential system extendibility to provide other services (e.g., providing recommendation online, broadcasting most trusted or valuable content to mobile devices, offering personalized reputation information based on subscription, etc.). Moreover, the system 100 can be part of a support platform for other mobile services that rely on reputation management and content recommendation systems.

The processes described herein for providing credibility information over an ad-hoc network may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to provide credibility information over an ad-hoc network as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of providing credibility information over an ad-hoc network.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to provide credibility information over an ad-hoc network. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for providing credibility information over an ad-hoc network. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for providing credibility information over an ad-hoc network, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, motion sensor, or touch-enabled screen, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for providing credibility information over an ad-hoc network.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set 900 upon which an embodiment of the invention may be implemented. Chip set 900 is programmed to provide credibility information over an ad-hoc network as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 900, or a portion thereof, constitutes a means for performing one or more steps of providing credibility information over an ad-hoc network.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to provide credibility information over an ad-hoc network. The memory 905 also stores the data associated with or generated by the execution of the inventive steps.

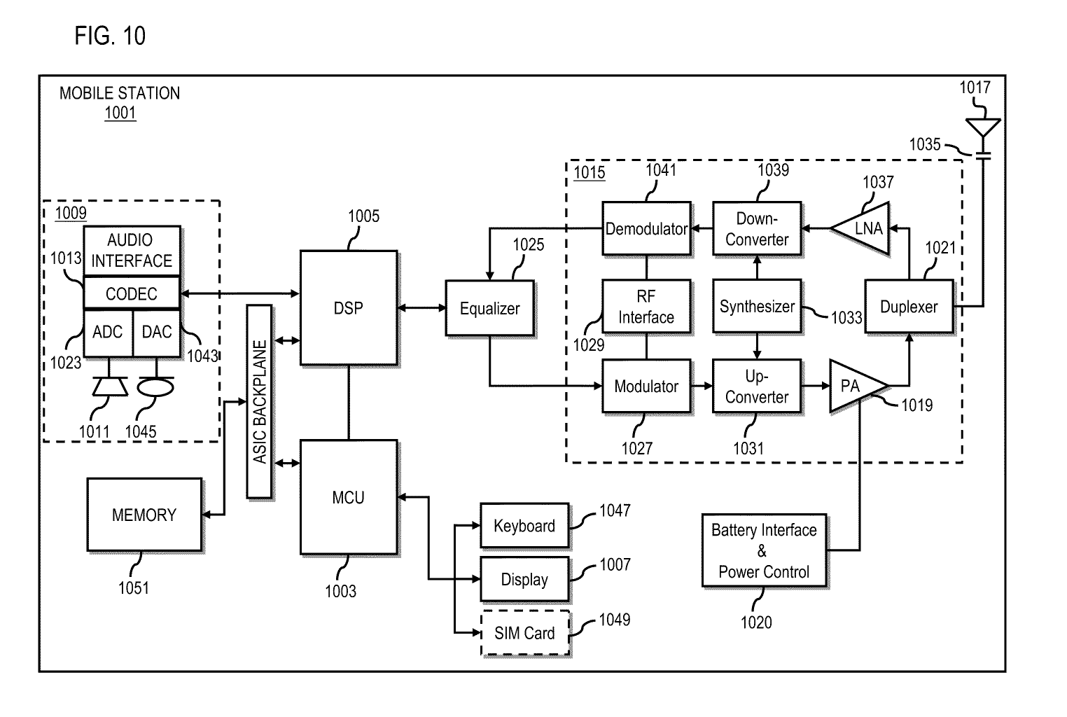

FIG. 10 is a diagram of exemplary components of a mobile terminal (e.g., mobile device, telephone, or handset) for communications, which is capable of operating in the system of FIG. 1, according to one embodiment. In some embodiments, mobile terminal 1000, or a portion thereof, constitutes a means for performing one or more steps of providing credibility information over an ad-hoc network. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of providing credibility information over an ad-hoc network. The display 10 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to provide credibility information over an ad-hoc network. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving content from a transmitting node over an ad-hoc network;
retrieving one or more trust values associated with the content, the transmitting node, or both, wherein the trust values are assigned by a trust server;
conducting a local evaluation of credibility information regarding the content, the transmitting node, or both; and
generating one or more combined trust values for the content, the transmitting node, or both from the trust values and the local evaluation.

2. A method of claim 1, further comprising:
retrieving at least one of node rating information provided by other nodes in the ad-hoc network, content rating information provided by the other nodes, and trust values associated with the other nodes providing the node rating information and the content rating information; and
conducting the local evaluation of the credibility information based, at least in part, on the node rating information, the content rating information, and the trust values associated with the other nodes.

3. A method of claim 1, further comprising:
receiving the content from the transmitting node through a relaying node;
retrieving a trust value associated with the relaying node; and
conducting the local evaluation of credibility information based, at least in part, on the trust value associated with the relaying node.

4. A method of claim 1, wherein the transmitting node is identified by a periodically changing anonymous identifier, and wherein the local evaluation is conducted on credibility information corresponding to the anonymous identifier since the anonymous identifier last changed.

5. A method of claim 3, wherein the trust value associated with the transmitting node, the node rating information, the content rating information, the trust values associated with the other nodes providing the node rating information and the content rating information, the trust value associated with the relaying node, or a combination thereof are caused, at least in part, to be transmitted with the content.

6. An apparatus comprising:
at least one processor; and
at least one memory including computer program code,
the at least one memory and the computer program code configured to, with the at least one processor, cause the apparatus to perform at least the following,
receive content from a transmitting node over an ad-hoc network,
retrieve one or more trust values associated with the content, the transmitting node, or both, wherein the trust values are assigned by a trust server,
conduct a local evaluation of credibility information regarding the content, the transmitting node, or both, and
generate one or more combined trust values for the content, the transmitting node, or both from the trust values and the local evaluation.

7. An apparatus of claim 6, wherein the apparatus is further configured to:
retrieve at least one of node rating information provided by other nodes in the ad-hoc network, content rating information provided by the other nodes, and trust values associated with the other nodes providing the node rating information and the content rating information; and
conduct the local evaluation of the credibility information based, at least in part, on the node rating information, the content rating information, and the trust values associated with the other nodes.

8. An apparatus of claim 6, wherein the apparatus is further configured to:
receive the content from the transmitting node through a relaying node;
retrieve a trust value associated with the relaying node; and
conduct the local evaluation of credibility information based, at least in part, on the trust value associated with the relaying node.

9. An apparatus of claim 6, wherein the transmitting node is identified by a periodically changing anonymous identifier, and wherein the local evaluation is conducted on credibility information corresponding to the anonymous identifier since the anonymous identifier last changed.

10. An apparatus of claim 8, wherein the apparatus is a mobile device configured to operate over the ad-hoc network further comprising:
user interface circuitry and user interface software configured to facilitate user control of at least some functions of the mobile phone through use of a display and configured to respond to user input; and
a display and display circuitry configured to display at least a portion of a user interface of the mobile phone, the display and display circuitry configured to facilitate user control of at least some functions of the mobile phone.

11. A method comprising:
collecting credibility information regarding content transmitted by nodes operating over an ad-hoc network;
generating trust values corresponding to the content, the nodes, or both based, at least in part, on the credibility information; and
causing, at least in part, actions that result in transmission of the trust values to at least one of the nodes,
wherein the nodes use the trust values in combination with local evaluations of the credibility information to generate combined trusts values for the content, the nodes, or both.

12. A method of claim 11, further comprising:
retrieving a first set of credibility information associated with the nodes from the collected credibility information, wherein the first set of credibility information include at least one of historical communication records, historical recommendation records, historical rating records, or a combination thereof;
generating the trust values corresponding to the nodes based, at least in part, on the first set of credibility information associated with the nodes;
retrieving a second set of credibility information associated with the content from the collected credibility information, wherein the second set of credibility information includes at least one of content rating information, content recommendation information, trust values associated with nodes providing the rating or recommendation information, content usage records, or a combination thereof; and
generating the trust values corresponding to the content based, at least in part, on the second set of credibility information.

13. A method of claim 11, wherein the credibility information that is more recent is more heavily weighted in generating the trust values.

14. A method of claim 11, further comprising:
periodically changing anonymous identifiers associated with the nodes, wherein the anonymous identifiers identify the nodes over the ad-hoc network; and
updating the trust values and the credibility information corresponding to the nodes based on the changed anonymous identifiers.

15. A method of claim 11, wherein the trust values are transmitted to the nodes as trust certificates.

16. An apparatus comprising:
at least one processor; and
at least one memory including computer program code,
the at least one memory and the computer program code configured to, with the at least one processor, cause the apparatus to perform at least the following,
collect credibility information regarding content transmitted by nodes operating over an ad-hoc network,
generating trust values corresponding to the content, the nodes, or both based, at least in part, on the credibility information, and
causing, at least in part, actions that result in transmission of the trust values to at least one of the nodes,
wherein the nodes use the trust values in combination with local evaluations of the credibility information to generate combined trusts values for the content, the nodes, or both.

17. An apparatus of claim 16, wherein the apparatus is further caused to:
retrieve a first set of credibility information associated with the nodes from the collected credibility information, wherein the first set of credibility information include at least one of historical communication records, historical recommendation records, historical rating records, or a combination thereof;
generate the trust values corresponding to the nodes based, at least in part, on the first set of credibility information associated with the nodes;
retrieve a second set of credibility information associated with the content from the collected credibility information, wherein the second set of credibility information includes at least one of content rating information, content recommendation information, trust values associated with nodes providing the rating or recommendation information, content usage records, or a combination thereof; and
generate the trust values corresponding to the content based, at least in part, on the second set of credibility information.

18. An apparatus of claim 16, wherein the credibility information that is more recent is more heavily weighted in generating the trust values.

19. An apparatus of claim 11, wherein the apparatus is further caused to:
periodically change anonymous identifiers associated with the nodes, wherein the anonymous identifiers identify the nodes over the ad-hoc network; and
update the trust values and the credibility information corresponding to the nodes based on the changed anonymous identifiers.

20. An apparatus of claim 11, wherein the trust values are transmitted to the nodes as trust certificates.
